(19) United States
(12) Patent Application Publication
(10) Pub. No.: US 2024/0286774 A1
(43) Pub. Date: Aug. 29, 2024

(54) UNMANNED AERIAL VEHICLE, CONTROL METHOD, AND UNMANNED AERIAL VEHICLE DEFENSE SYSTEM

(71) Applicant: Alan Taylor, Myakka City, FL (US)

(72) Inventor: Alan Taylor, Myakka City, FL (US)

(21) Appl. No.: 18/587,942

(22) Filed: Feb. 26, 2024

Related U.S. Application Data
(60) Provisional application No. 63/448,238, filed on Feb. 24, 2023.

(51) Int. Cl. B64U 20/83; B64U 20/87; B64U 101/18

(52) U.S. Cl. CPC B64U 20/83; B64U 20/87; B64U 2101/18

(57) ABSTRACT

An unmanned aerial vehicle (UAV), a UAV control method, and a UAV defense system are described.

### RELATED APPLICATIONS

This application claims the benefit of U.S. Application No. 63/448,238, entitled “UNMANNED AERIAL VEHICLE & METHOD,” and filed on Feb. 24, 2023, which is incorporated herein by reference in its entirety.

### FIELD

Some implementations relate generally to unmanned aerial vehicles, and, more particularly, unmanned aerial vehicle, control method, and unmanned aerial vehicle defense system.

### BACKGROUND

Unmanned aerial vehicles (or UAVs or drones) are increasingly used in warfare. Consequently, countermeasures have been developed to reduce or eliminate the risk of UAV hitting an intended target. Unfortunately, while some of the countermeasure systems may disrupt the ability of an attacking UAV to fly to its intended target, the countermeasure systems may unintentionally and indiscriminately cause the UAV to crash, which may cause any ordinance the attacking UAV is carrying to detonate. Because the attacking UAV may be brought down without regard to people or building below the flight path of the attacking UAV, the ordinance detonate may cause unintended collateral damage such as injury to people from explosive shock waves or projectiles.

A need may exist for a UAV, a UAV control method and a UAV defense system that is configured to defeat an attacking UAV while giving additional time to people below the attacking UAV to move away from the area where the attacking UAV will crash. Thus, helping to avoid injury from proximity to detonation of ordinance carried by the attacking UAV.

Embodiments were conceived in light of the above-mentioned problems and limitations, among other things. The background description provided herein is for the purpose of generally presenting the context of the disclosure. Work of the presently named inventor(s), to the extent it is described in this background section, as well as aspects of the description that may not otherwise qualify as prior art at the time of filing, are neither expressly nor impliedly admitted as prior art against the present disclosure.

### SUMMARY

Some implementations can include.

### BRIEF DESCRIPTION OF THE DRAWINGS

FIG. 1 is a front perspective view of an example unmanned aerial vehicle in accordance with some implementations.

### DETAILED DESCRIPTION

As used herein, the term click-lock or click-lock assembly or mechanism refers to the click-lock assemblies described in a U.S. Patent Application entitled “CLICK-LOCK ASSEMBLIES” filed on an even date with this application, and which is incorporated herein by reference in its entirety.

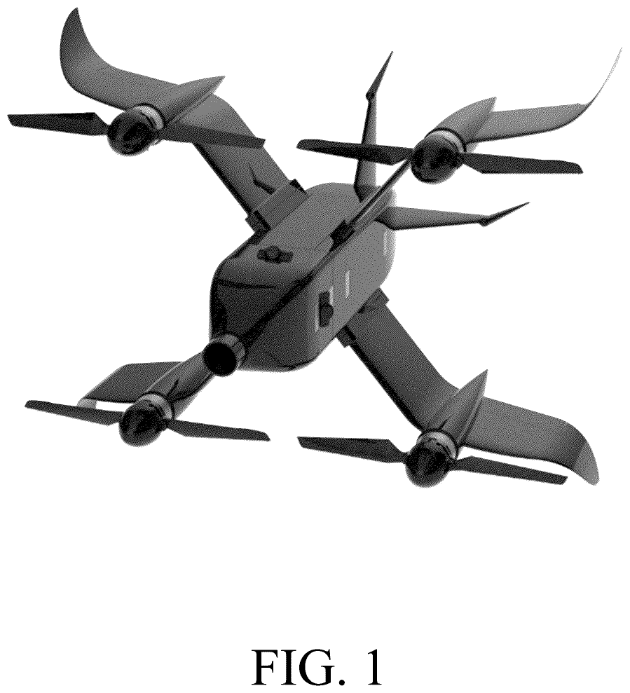

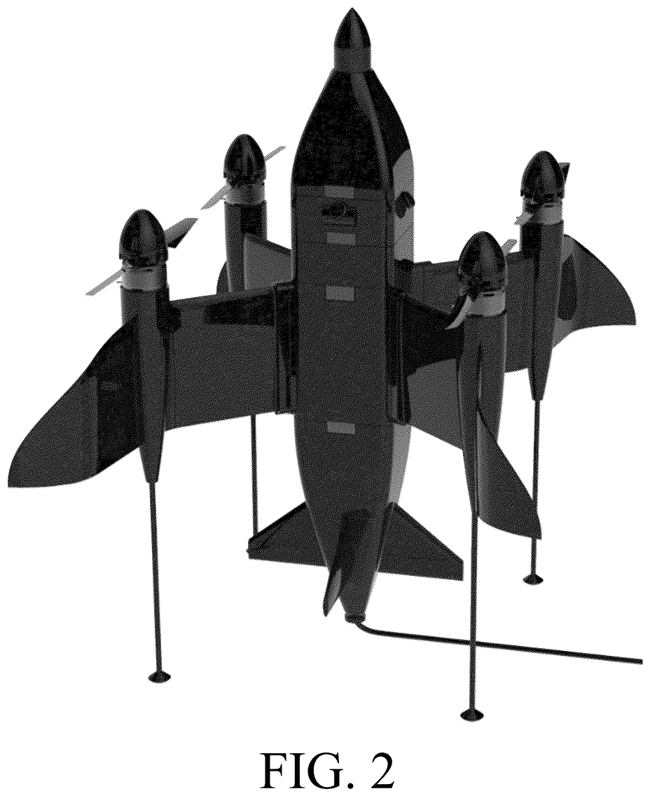

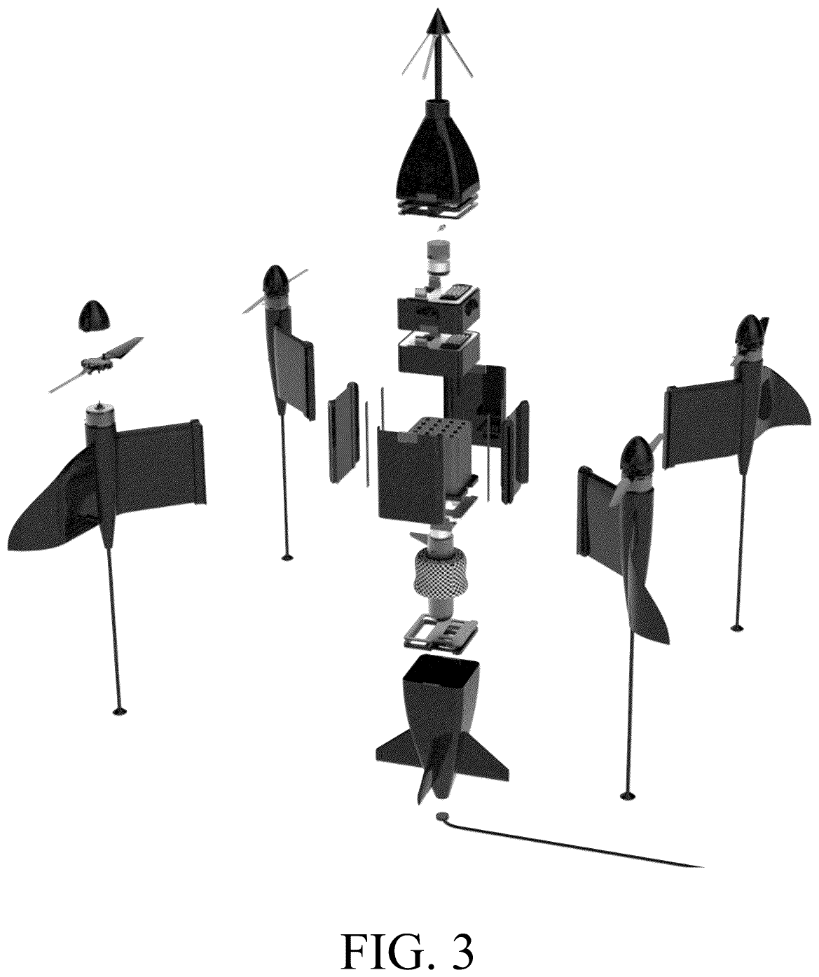

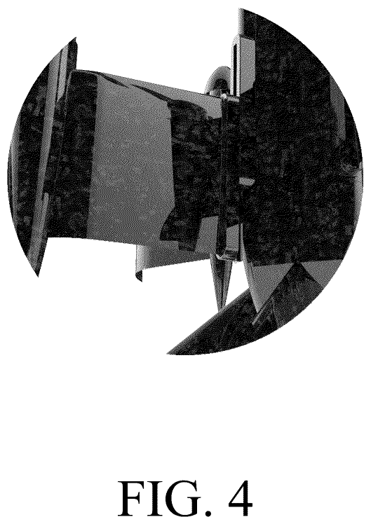

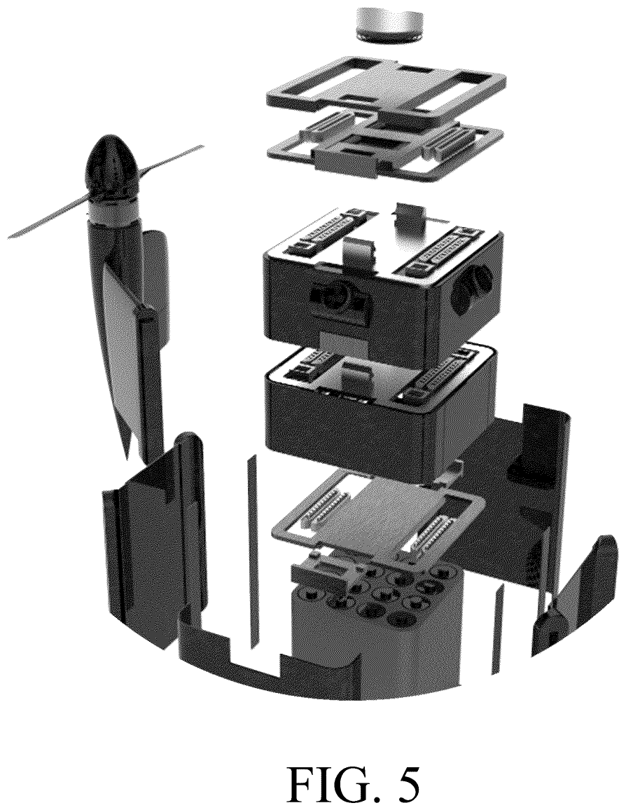

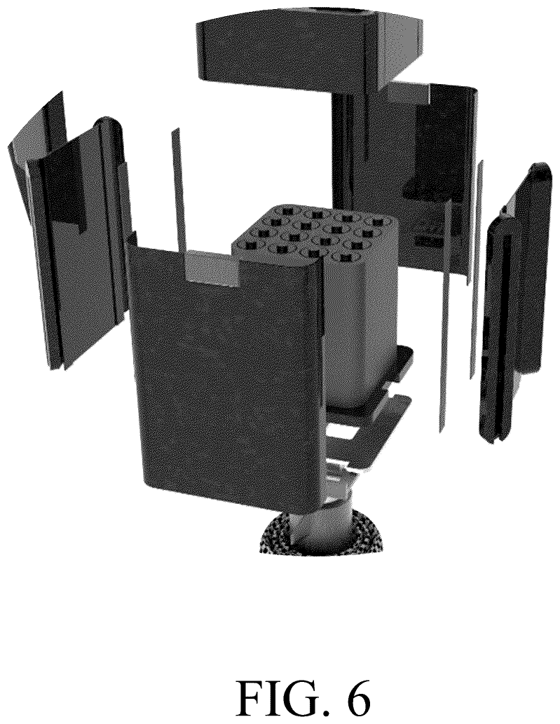

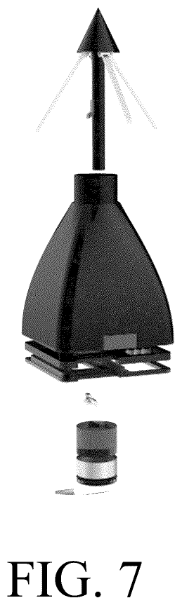

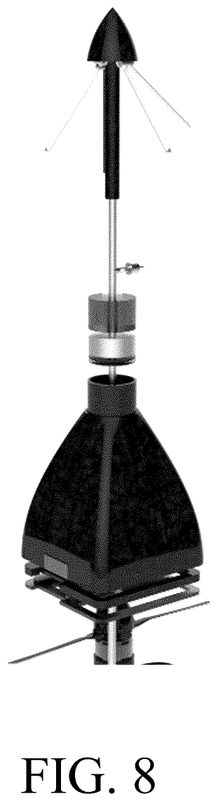

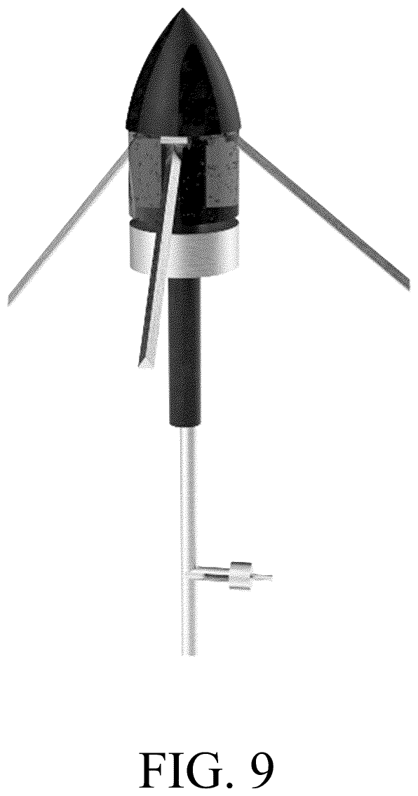

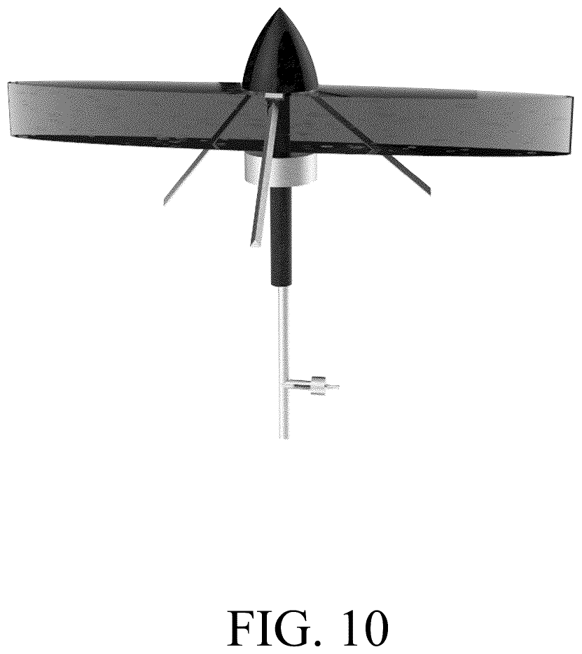

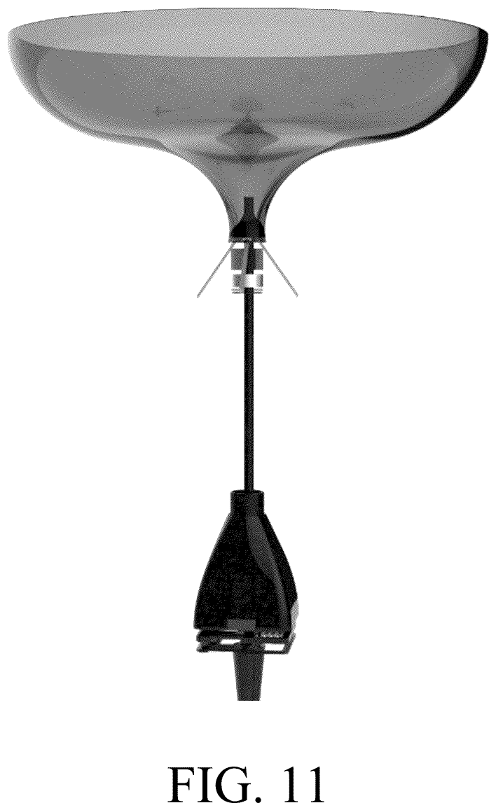

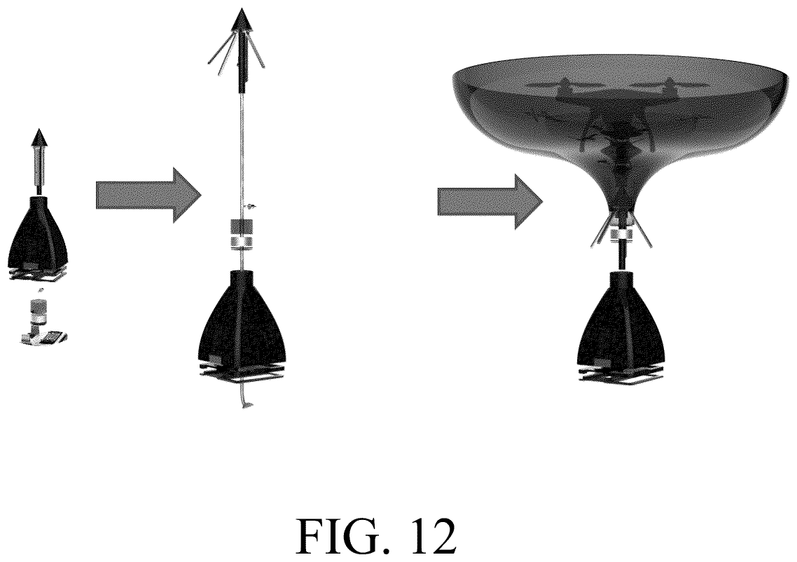

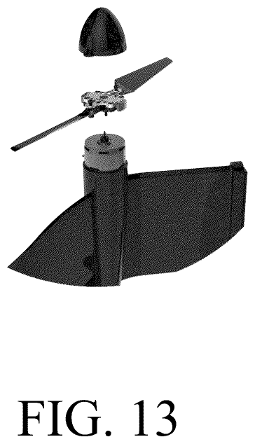

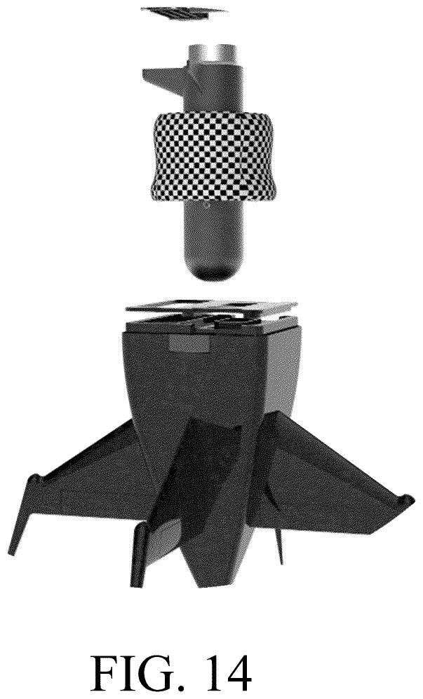

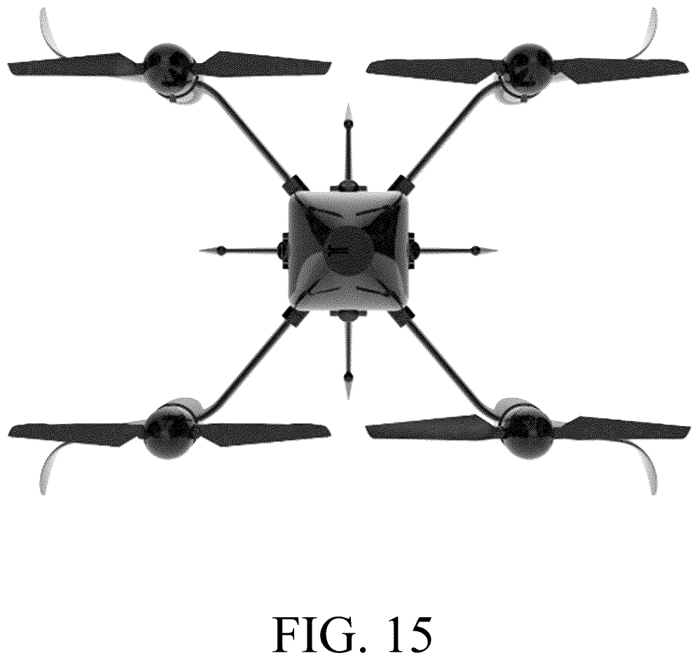

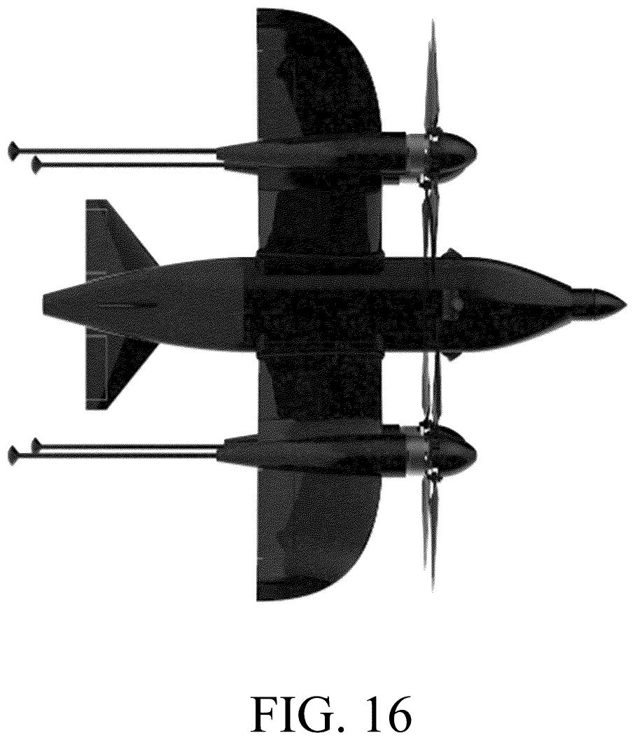

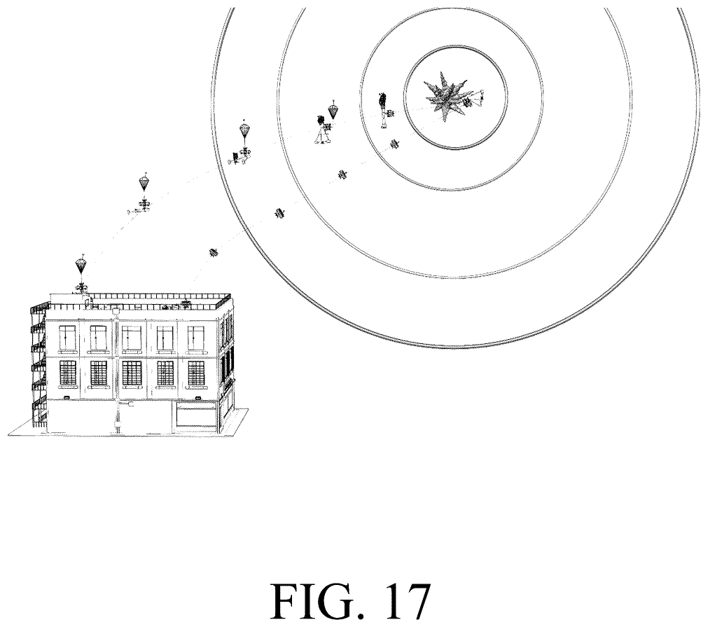

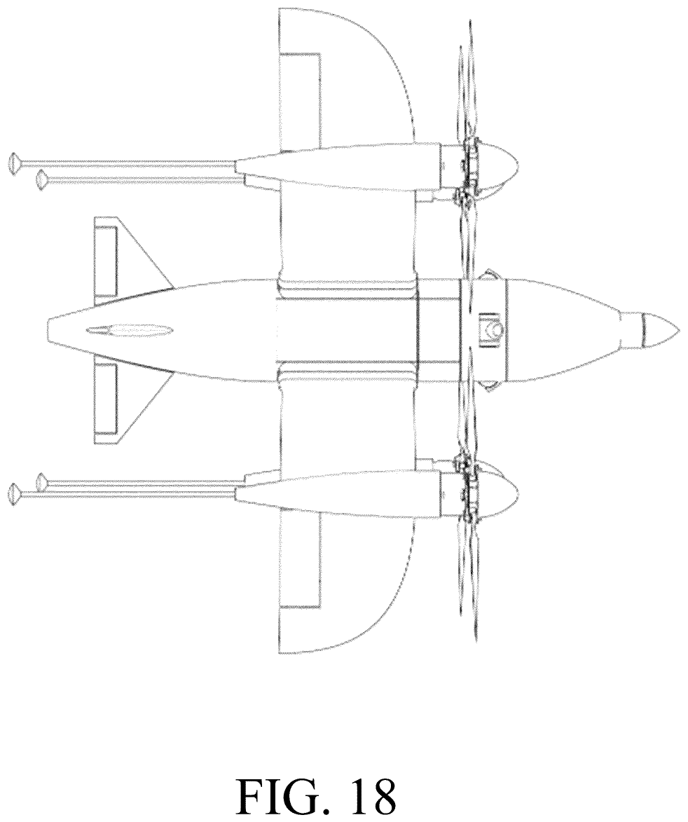

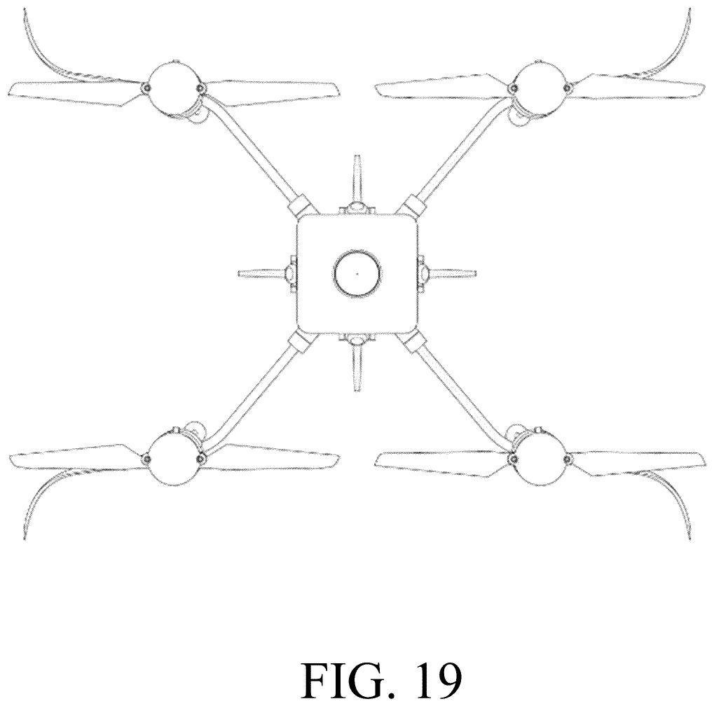

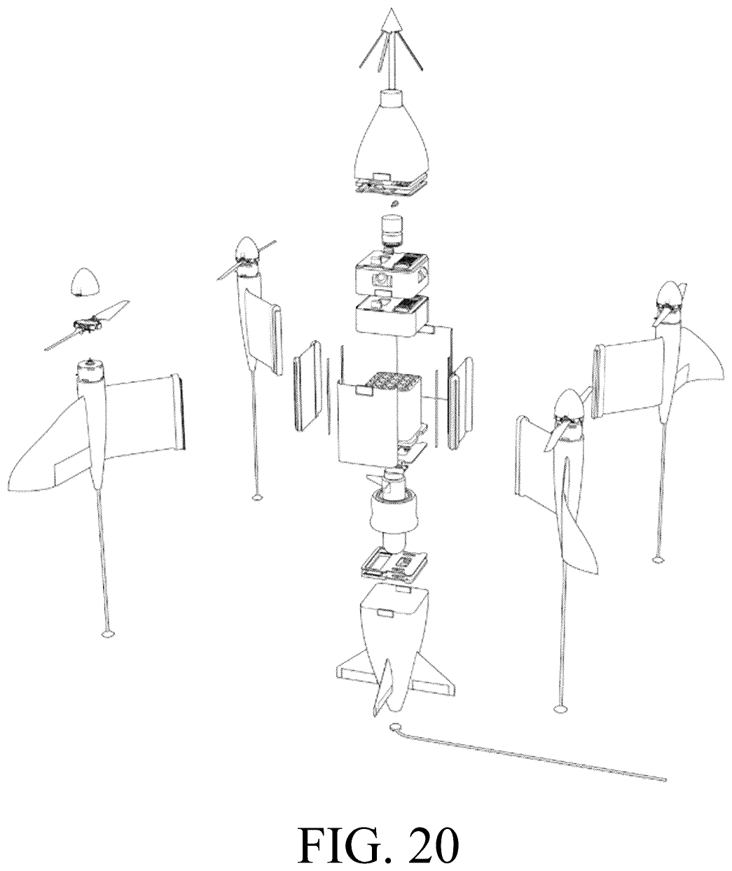

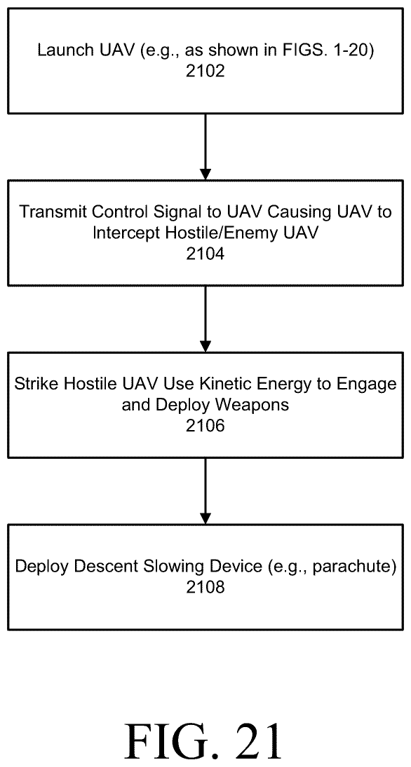

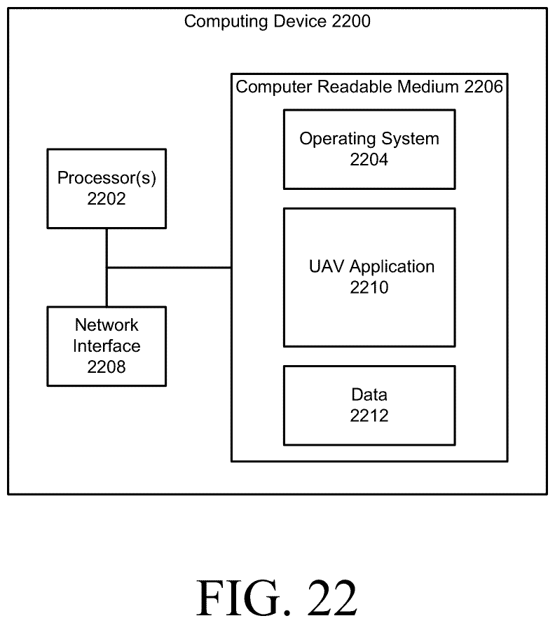

FIG. 1 is a front perspective view of an example unmanned aerial vehicle (UAV or drone) in accordance with some implementations.

FIG. 2 is a diagram of an example unmanned aerial vehicle in accordance with some implementations. In particular, the UAV can include a Click-lock removable electronics housing for most critical tech items, such as autopilot, comms links and speed controls. This can include a finned box for natural convection, and/or heat sinking.

In an example, a 1 or 2 button click-lock battery module features either 18650 or 21700 lithium-ion cells arranged in-line or transverse. Note this payload can be transposed with the upper electronics payload should a more easily swappable position be desired. This would eliminate a need to remove the wings and consequently would affect the Cg.

Some implementations can include click-lock removable carbon fiber, reinforced EPP foam, plastic or even aluminum wings with ailerons.

Some implementations can include a click-lock 4× camera payload module, featuring 360 degree viewing to detect incoming drones when weaponized. These cameras may alternatively be mounted to the conical munition head, whereby providing a better elevation viewing angle. Other options are available for a front mounted 3-axis gimbal camera with slip rings for ISR missions.

Some implementations can include an optionally combined or not, click-lock weapon and/or sensor payloads that are swappable. Possible versions include EO/IR optics, white phosphorous sensors, gimbal sensors, a 12-gauge shotgun, 40 mm grenade launcher, an incendiary petroleum jelly puck launcher, less than lethal weapons and other comparable munitions.

Some implementations can include click-lock wings that may be fabricated in two or even three sections and joined together on foam, balsa or an alike structure. These may be split between two halves running from the leading edge to trailing edge or having three parts making a leading-edge cap and two halve behind it. They may also feature insert molded 3/phase conductors and dove tail slides for mounting.

Some implementations can include a modular click-lock, tapered 4 fin tail, with rudder and elevator control for a high degree of maneuverability. Some implementations can feature a BRS or other kinetic parachute assembly providing a controlled decent after intercepting and/or incinerating an enemy drone.

Some implementations can include a removable electrical cable that separates with magnetic connection on takeoff to allow for 24/hour perch and stare.

FIG. 3 is an exploded view of an example UAV in accordance with some implementations. Some implementations can include a click-lock weapon and/or munition payload that can be molded in two sections and joined via epoxy and mechanical fasteners or induction welded/thermally fused/welded.

In some implementations, a new, click-lock weapon uses a 40 mm barrel with a front mounted St. Gobain tungsten igniter that is energized and heated 20 seconds prior to impact. Upon impact, inertia causes a steel puck at the distal end to fly forward pushing an incendiary petroleum jelly encased in thin plastic into the igniter and forcing it to spray outward in a 360 degree pattern. This is intended to engulf an enemy drone like the Iranian Shahed drone in a fire ball, whereby igniting its munition payload while still in the air rather than on the ground.

As shown in FIG. 3 red strips represent a novel approach to bonding a fuselage together using thin VHB coupled with thermoplastic featuring a susceptor particles that can be inductively heated while under clamp pressure providing a superior, homogeneous bond to between the 4 sides or even 6 sided boxes. The VHB component provides an initial peel and stick feature to make initial assembly easy and gets either burnt off or melds together in the induction welding process. Tape can be used to secure carbon structure and frame together as one piece.

As shown in FIG. 3:
UAV modules can include click-lock assemblies.
360-degree cameras
Folding click-lock prop assembly with an optional spinner
A parachute is launched via a solid fuel rocket or in some other kinetic method, the tail section falls away on impact while the chute unfurls.
Rear Sensor payload will be molded in two sections and joined via epoxy and mechanical fasteners or inductively/thermally fused/welded.
Incendiary Jelly Puck
Steel Puck
Click-lock, dovetail slide-in detachable wings
Lithium-Ion Battery Pack
Click-lock wing release assembly.
Charging and perching cable.

FIG. 4 shows details of a UAV wing connection in accordance with some implementations. Click-lock dovetail slide ensures a quick and secure wing attachment and easy removal. This may also be accomplished with a tongue and groove feature as well.

Wings are detachable with a single push button for easy repairability and compact storage.

FIG. 5 shows an example click lock electrical interfacing in accordance with some implementations. Striker tangs can be used to interlock assembly into place. There is one on each side, equal and opposite of one another.

Electronic connectors can be conventional pogo pins, cage pins, coax, magnetic and even induction designs. This added feature allows a very fast electrical connection between modules for power, comms, antennas, munitions, igniters and more, after only being click-locked into place. This provides electrical connectivity between sections while securing them together at the same time.

FIG. 6 shows carbon fiber construction methodology in accordance with some implementations. VHB coated thermoplastic tape featuring susceptor particles for pre-assembly using the double VHB component and then later once assembled into a monocoque sub-assembly gets homogeneously fused/melded together using induction welding.

Carbon fiber parts feature lap joints (overlap one-another). This construction method initially utilizes epoxy and, in some instances, may utilize a secondary mechanical fastener. Alternatively, these structures can be joined using a double sided VHB coated induction welding, thermoplastic tape. This is a way to secure all 4 sections of fuselage together and create a homogeneous bond without the use of epoxy or mechanical fasteners that is mechanically, far superior. It's also far easier to create hermetically sealed structures.

FIG. 7-11 show example weapon payload on impact in accordance with some implementations. In some implementations, on impact, inertia forces the steel puck to slide along the grapnels (optionally telescoping shaft or tethered) shaft, whereby forcing the grapnel arrow out of the 40 mm barrel, penetrating a target such as the Iranian Shahad drone, spearing in an effort to cling on with its folding flukes and control its decent. Simultaneously, the steel puck pushes the incendiary, petroleum jelly puck through the tungsten igniter, causing a rapid exothermic reaction creating a spattering jelly fire ring as it compresses and pushes away from the tip in a 360-degree manner. The intent is to engulf and consequently cause the enemy drone to burn up and explode its payload in the sky while the parachute system slows its descent in a controlled manner, providing bystander's enough time to run and seek shelter.

FIG. 12 shows an example three step weapon impact in accordance with some implementations.
STEP 1-spike impales into unknown drone
STEP 2-spike flares open catching drone from falling to ground.
STEP 3-liquid ingulfs drone from steel puck and igniter sets fire to remove all particles from the air.

On impact, inertia forces the steel puck to slide along the grapnels (optionally telescoping shaft or tethered) shaft, whereby forcing the grapnel arrow out of the 40 mm barrel, penetrating a target such as the Iranian Shahad drone, spearing in an effort to cling on with its folding flukes and control its decent. Simultaneously, the steel puck pushes the incendiary, petroleum jelly puck through the tungsten igniter, causing a rapid exothermic reaction creating a spattering jelly fire ring as it compresses and pushes away from the tip in a 360-degree manner. The intent is to engulf and consequently cause the enemy drone to burn up and explode its payload in the sky while the parachute system slows its descent in a controlled manner, providing bystander's enough time to run and seek shelter.

FIG. 12 shows:
UFO enemy drone
Braided Steel cable
Tungsten igniter
Liquid
Steel puck
Liquid
Steel puck pushes liquid out and engulfs drone

FIG. 13 shows an example nacelle payload exploded view in accordance with some implementations.

Some implementations can include Patented and Patent-Pending click-lock, folding rotor assembly, which can be used with folding rotors, propellors or even fixed ones. It can also utilize an optional spinner or nose cone. This is in no way limited to VTOL or transitional aircraft.

FIG. 14 shows an example tail section/recovery device in accordance with some implementations. The tail section would be jettisoned prior to the rocket ignition. Perhaps using a servo, linear actuator or solenoid.

This example depicts a solid fuel rocket with folding fins that fires on impact. This version fully deploys a stretches the large tethered parachute to slow the decent of both the UAV and its target to the ground in a controlled manner. The rocket features folding hinged fins that pop-out as it flies rearward. The chute is folded asymmetrically to ensure it falls away without becoming entangled.

The parachute unfurls as the rocket pulls away to ensure quick deployment and maximum detonation delay.

FIG. 16 shows an example operational UAV scenario in accordance with some implementations. Versatile Deployment Options: Launching from virtually any location, the disclosed UAV offers versatility, including deployment from the top of a building. This capability enables rapid interception of incoming threats from the safety of a secured location building, ensuring a swift and effective response to a wide array of operational scenarios.

FIG. 16 shows:
1. drone deploys when target has been acquired.
2. drone tracks target using 360 degrees, penetrates target using spike and jelly fire to engulf target.
3. drone deploys a parachute to safely carry drone and target to the ground.

FIG. 21 is a flowchart showing an example UAV defense system control method. Processing begins at 2102, where a UAV (e.g., as shown in FIGS. 1-21) is launched. Processing continues to 2104.

At 2104, a control signal is transmitted to the UAV causing the UAV to fly a course to intercept a hostile/enemy UAV. The control signal can be transmitted from an operator, from an external automated system configured to defend against UAV attacks, or the signal can be a signal causing the UAV to go into a mode in which the UAV automatically searches for and engages hostile UAVs when detected. Processing continues to 2106.

At 2106, the UAV engages the hostile UAV as described herein and deploys weapons. Processing continues to 2108.

At 2108, a parachute or other system is deployed to slow descent of the UAV and hostile UAV.

FIG. 22 is a diagram of an example computing device 2200 in accordance with at least one implementation. The computing device 2200 includes one or more processors 2202, nontransitory computer readable medium 2206 and network interface 2208. The computer readable medium 2206 can include an operating system 2204, an application 2210 for UAV control and a data section 2212 (e.g., for storing UAV flight information, enemy UAV information, etc.).

In operation, the processor 2202 may execute the application 2210 stored in the computer readable medium 2206. The application 2210 can include software instructions that, when executed by the processor, cause the processor to perform operations to control one or more UAVs in accordance with the present disclosure (e.g., performing associated functions described above and shown in FIGS. 1-21).

The application program 2210 can operate in conjunction with the data section 2212 and the operating system 2204.

It will be appreciated that the modules, processes, systems, and sections described above can be implemented in hardware, hardware programmed by software, software instructions stored on a nontransitory computer readable medium or a combination of the above. A system as described above, for example, can include a processor configured to execute a sequence of programmed instructions stored on a nontransitory computer readable medium. For example, the processor can include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C, C++, C#.net, assembly or the like. The instructions can also comprise code and data objects provided in accordance with, for example, the Visual Basic™ language, or another structured or object-oriented programming language. The sequence of programmed instructions, or programmable logic device configuration software, and data associated therewith can be stored in a nontransitory computer-readable medium such as a computer memory or storage device which may be any suitable memory apparatus, such as, but not limited to ROM, PROM, EEPROM, RAM, flash memory, disk drive and the like.

Furthermore, the modules, processes systems, and sections can be implemented as a single processor or as a distributed processor. Further, it should be appreciated that the steps mentioned above may be performed on a single or distributed processor (single and/or multi-core, or cloud computing system). Also, the processes, system components, modules, and sub-modules described in the various figures of and for embodiments above may be distributed across multiple computers or systems or may be co-located in a single processor or system. Example structural embodiment alternatives suitable for implementing the modules, sections, systems, means, or processes described herein are provided below.

The modules, processors or systems described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and/or a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any processor capable of implementing the functions or steps described herein can be used to implement embodiments of the method, system, or a computer program product (software program stored on a nontransitory computer readable medium).

Furthermore, embodiments of the disclosed method, system, and computer program product (or software instructions stored on a nontransitory computer readable medium) may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a VLSI design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of the software engineering and computer networking arts.

Moreover, embodiments of the disclosed method, system, and computer readable media (or computer program product) can be implemented in software executed on a programmed general-purpose computer, a special purpose computer, a microprocessor, a network server or switch, or the like.

While some example implementations have been described in terms of a general embodiment with several specific example modifications, it is recognized that other modifications and variations of the embodiments described above are within the spirit and scope of the disclosed subject matter. Applicant intends to embrace any and all such modifications, variations and embodiments.

What is claimed is:

1. An unmanned aerial vehicle.

2. A method of controlling an unmanned aerial vehicle.

3. An unmanned aerial defense system.
